(19) United States
(12) Patent Application Publication
(10) Pub. No.: US 2008/0099317 A1
(43) Pub. Date: May 1, 2008

(54) SERVICE SWITCHING DEVICE AND CONNECTION TERMINAL FOR A SERVICE SWITCHING DEVICE

(75) Inventors: Ralf WEBER, Heidelberg (DE); Klaus-Peter Eppe, Waldbrunn (DE)

Correspondence Address: BUCHANAN, INGERSOLL & ROONEY PC, POST OFFICE BOX 1404, ALEXANDRIA, VA, 22313-1404, US

(73) Assignee: ABB PATENT GMBH, Ladenburg (DE)

(21) Appl. No.: 11/925,320

(22) Filed: Oct. 26, 2007

(30) Foreign Application Priority Data
Oct. 28, 2006 (DE) 10 2006 050 932.3
Sep. 3, 2007 (DE) 10 2007 041 650.6

(51) Int. Cl. H01H 9/02; H01R 4/36

(52) U.S. Cl. 200/293; 439/810

(57) ABSTRACT

A service switching device is disclosed which includes a housing. The housing includes a face side, a fastening side and a narrow side lying therebetween. A connection terminal is held in a terminal accommodating area of the housing which is located in the vicinity of the narrow side. The connection terminal includes a clamping screw, which is accessible from the face side, having an actuating end and a clamping end opposite the actuating end. A clamping body, in which a busbar and/or a connecting conductor can be pressed against a conductor bar by the clamping screw, is accessible via a first housing opening in the wall of the narrow side. The clamping area can be covered by a terminal covering part. The terminal covering part is coupled to the clamping end of the clamping screw and can be carried along thereby in the movement direction of the clamping screw. It can point in the direction of the face side and can be dimensioned such that it completely covers the clamping area even when the clamping screw has been screwed onto the conductor bar.

### CROSS REFERENCE TO RELATED APPLICATIONS

The present application claims priority under 35 U.S.C. §119 to German Application Nos. 10 2006 050 932.3 filed Oct. 28, 2006, and 10 2007 041 650.6 filed Sep. 30, 2007, the contents of which are hereby incorporated by reference in their entirety.

### BACKGROUND

1. Field

A service switching device having a housing and a connection terminal held in a terminal accommodating area of the housing is disclosed.

A connection terminal for installation in the terminal accommodating area of a service switching device is also disclosed.

2. Background Information

EP 809 325 B1 has disclosed a service switching device of the generic type having a twin-chamber terminal. A headless screw bolt is in this case screwed into the cylindrical section of a clamping body. The screw can be screwed completely into the clamping body, so that it covers the supply opening in the housing. As a result, although a potential faulty connection has been addressed, there is unintentional touching contact with the terminal opening, which may result in safety hazards.

DE 44 36 780 C2 discloses a service switching device of the generic type having an L-shaped terminal covering part, which is inserted into a slot on the narrow side of the service switching device and is latched such that it is fixed in position within the slot. This can be cost-intensive in terms of production and complex in terms of fitting.

### SUMMARY

A service switching device of a generic type and a connection terminal of a generic type for a service switching device are disclosed, in which unintentional touching contact with live terminal parts can be avoided and which, in the process, can be manufactured in a simple and cost-effective manner.

An exemplary service switching device comprises a service switching device comprising: a housing having a face side, a fastening side and a narrow side lying therebetween; a connection terminal, which is held in a terminal accommodating area of the housing which is located in a vicinity of the narrow side, having a clamping screw, which is accessible from the face side, having an actuating end and a clamping end opposite said actuating end; a clamping body, in which a busbar and/or a connecting conductor can be pressed against a conductor bar by the clamping screw, the clamping body being accessible via a first housing opening in the wall of the narrow side; and a terminal covering part which is coupled to the clamping end of the clamping screw to be carried along thereby in a movement direction of the clamping screw, which points in a direction of the face side, and which is dimensioned to completely cover the clamping area even when the clamping screw has been screwed onto a conductor bar.

An exemplary connection terminal comprises a connection terminal for installation in the terminal accommodating area of a service switching device, comprising: a housing; a clamping screw, which has an actuating end and a clamping end opposite said actuating end; a clamping body, in which at least one clamping area is formed, in which a busbar and/or a connecting conductor can be pressed against a conductor bar by the clamping screw, and a terminal covering part, which is coupled to the clamping end of the clamping screw to be carried along thereby in a movement direction of the clamping screw, which points in a direction of the actuating end of the clamping screw, and which is dimensioned to completely cover the clamping area even when the clamping screw has been screwed onto a conductor bar.

### BRIEF DESCRIPTION OF THE DRAWINGS

Exemplary embodiments will be explained and described in more detail with reference to the drawings, in which:

FIG. 1 shows, schematically, a view from outside of an exemplary service switching device as disclosed herein;

FIG. 2 shows, schematically, a sectional view of a first exemplary embodiment of a connection terminal as disclosed herein;

FIG. 3 shows, schematically, a sectional view of a second exemplary embodiment of a connection terminal as disclosed herein;

FIG. 4 shows, schematically, the view of an exemplary terminal covering part disclosed herein;

FIG. 5 shows a further exemplary embodiment, in which the terminal covering part can be clipped into guide grooves in the housing opening with snap-action hooks; and

FIG. 6 shows a further exemplary embodiment, in which the terminal covering part contains (e.g., consists of) metal and the side with which touching contact can be made from the outside in the installed state is covered with an insulating material.

Identical or functionally identical components or elements have each been provided with the same reference numerals in the figures, even if they have a slightly modified form in various embodiments.

### DETAILED DESCRIPTION

As disclosed herein, an exemplary clamping area of a service switching device can be covered by a terminal covering part, which is coupled to the clamping end of a clamping screw, can be carried along thereby in a movement direction of a clamping screw, points in the direction of a face side and can be dimensioned such that it still completely covers the clamping area even when the clamping screw has been screwed onto the conductor bar.

An exemplary terminal covering part can be produced in a very cost-effective manner as a mass-produced part and, during manufacture of the service switching device, can easily be fitted to, for example snapped onto, the clamping end of the clamping screw. If a connecting conductor is inserted into the terminal and the terminal is then closed, i.e., if the clamping screw is tightened, then the terminal covering part can cover that part of the terminal which points from the clamping end in the direction of the actuating end of the clamping screw, as a result of which unintentional touching contact with the live terminal part between the clamping end and the actuating end of the clamping screw can be avoided.

In accordance with an exemplary embodiment, the service switching device has at least two clamping areas, which are accessible via a first and a second housing opening from that narrow side wall which is adjacent to the face side, lie one behind the other in relation to the face side and are separated from one another by a conductor bar inserted into the clamping body, for connecting a busbar and/or a connecting conductor, a first clamping area, which lies between the conductor bar and the face side, being capable of being covered by a terminal covering part, which is coupled to the clamping end of the clamping screw, can be carried along thereby in the movement direction of the clamping screw, can point in the direction of the face side and can be dimensioned such that it still completely covers the clamping area even when the clamping screw has been screwed onto the clamping piece.

The first clamping area of this exemplary embodiment can be provided for the connection of connecting wires, and the second clamping area can be provided for connecting the connection lugs of busbars. If a busbar is connected in the second clamping area, unintentional touching contact with the second clamping area can be virtually excluded in practice. Unintentional touching contact with the first clamping area can be avoided by the terminal covering part which has been fitted on the clamping screw and which can be carried along thereby.

In accordance with an exemplary embodiment, the terminal covering part can have an L shape, having a first limb, whose end is in the form of a fork, and with which the terminal covering part can be latched onto, also referred to as clipped onto, a groove at the clamping end of the clamping screw. The terminal covering part can be carried along thereby in the movement direction of the clamping screw, if the clamping screw is rotated. Its second limb can be dimensioned such that it still completely covers the first clamping area even when the clamping screw has been screwed onto the conductor bar.

This embodiment can make a particularly simple fitting of the terminal covering part possible.

In a further embodiment, the wall of the narrow side of the housing has first guide means on the longitudinal sides of the first housing opening. Second guide means are provided on the longitudinal sides of the second limb of the terminal covering part. The first and second guide means interact so as to guide the terminal covering part. In this case, the first guide means can be elongated grooves, and the second guide means can be snap-action hooks. An exemplary advantage of this configuration is that the terminal covering part can be inserted into the clamping area from the outside when the housing is closed and, in the process, can be clipped onto the clamping screw and the first housing opening. Owing to the guiding interaction between the first and the second guide means, the terminal covering part is then held, after the insertion, in the clamping area such that it is longitudinally displaceable.

An alternative embodiment provides that the terminal covering part has an L shape, having a first limb, which has an annular aperture. The clamping screw, in the region of its clamping end, passes through the aperture when the terminal covering part is fitted. In an exemplary configuration, the first limb with the annular aperture is coupled to a groove at the clamping end of the clamping screw. An exemplary advantage of this configuration that the terminal covering part is therefore connected undetachably to the clamping screw.

In an exemplary embodiment, the clamping screw can in this case be a headless screw bolt. This is because the configuration of the actuating end of the clamping screw need not be significant since the terminal covering part is fitted to the clamping end of the clamping screw. The headless screw bolt can be screwed very deep and completely into the clamping body and is moreover available as a very inexpensive mass-produced part.

In a further embodiment of a service switching device, the terminal covering part can be guided at least partially in the terminal accommodating area between the clamping body and the inside of the narrow side wall. In this case, it can be guided with its second limb in the terminal accommodating area between the clamping body and the inside of the narrow side wall. In this way, the terminal covering part can be accommodated in the housing interior in a space-saving manner and protected against unintentional damage from the outside.

As regards the clamping screw, an exemplary embodiment provides that it has, at the clamping end, a peripheral groove, in which the terminal covering part can be latched. Such a peripheral groove can also be introduced into already prefabricated screws during manufacture.

A further embodiment as regards the clamping screw provides that it has, at the clamping end, a coupling shoulder to which the terminal covering part can be coupled such that it can be carried along by it. One form of the coupling can in this case include (e.g., consist of) clipping-on.

Furthermore, a pressure plate for pressing the connecting conductor or the busbar against the conductor bar can be fitted to the coupling shoulder. In interaction with the coupling shoulder, the pressure plate in this case can serve a purpose of producing the groove, onto which the terminal covering part can be clipped.

In an exemplary embodiment, the pressure plate is guided rotatably at the clamping end of the clamping screw. That is to say if a connecting conductor is intended to be inserted between the pressure plate and the conductor bar, then the connecting conductor could rotate when the clamping screw is tightened; this can be prevented if the pressure plate is guided rotatably on the clamping screw.

In an exemplary embodiment with the pressure plate, the first limb of the L-shaped terminal covering part can be configured to be annular and to guide it with the inner cutout of the ring over the coupling shoulder. By positioning and fastening the pressure plate, the terminal covering part can be then prevented from falling off. An exemplary type of fastening for the pressure plate on the coupling shoulder is in this case riveting.

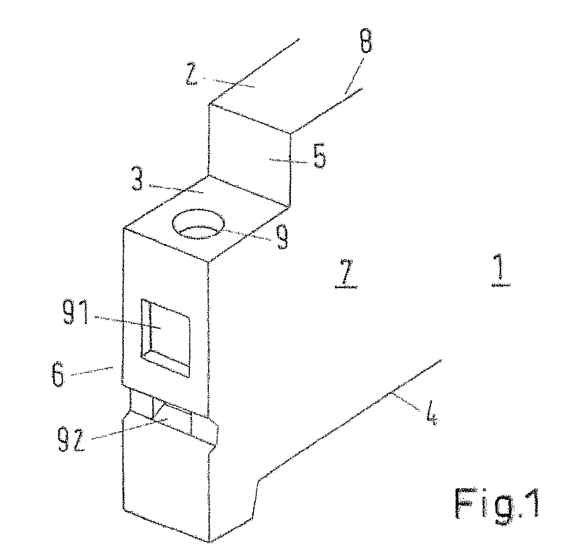

FIG. 1 shows, schematically, a partial view of a service switching device 1 having a front face side 2, a rear face side 3, a fastening side 4 which is opposite the face side, a front narrow side 5 which connects the front and the rear face side, a rear narrow side 6 which connects the rear face side 3 and the fastening side 4, and two broad sides 7, of which only one is visible in FIG. 1.

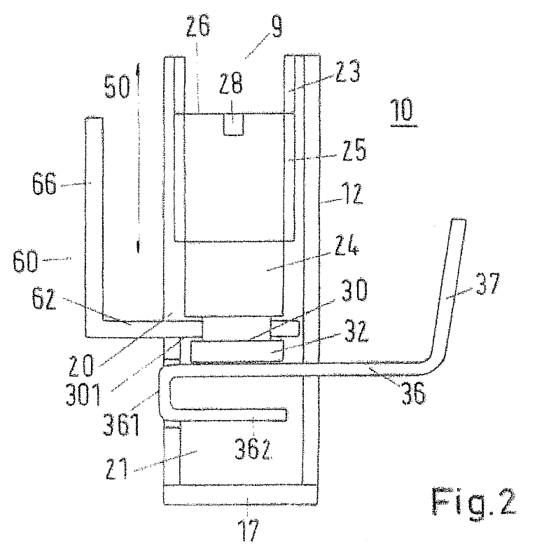

Formed in the region between the rear face side 3 and the rear narrow side 6, in the interior of the housing 8 of the service switching device, is a terminal accommodating area (not shown here), in which a connection terminal 10 (see FIG. 2) is held. The connection terminal 10 comprises a clamping screw 24, which is accessible from the rear face side 3 through a terminal opening 9, and a front clamping area 20 and a rear clamping area 21, which, when viewed from the face side, are arranged one behind the other and are accessible through a front 91 and a rear housing opening 92 in the rear narrow side 6 of the housing for connection of a connecting conductor or a busbar or the connection lug of a busbar.

The first, front housing opening 91 has approximately a rectangular contour extending in the longitudinal direction of the rear narrow side 6 and serves the purpose of connecting connecting wires. The second, rear housing opening 92 is fitted in a channel-shaped shoulder in the rear narrow side 6 and has a transverse rectangular contour. It is provided for clamping on the connection lug of a busbar.

FIG. 2 shows, in a schematic sectional illustration, an embodiment of a connection terminal 10. This comprises a clamping body 12, which may be designed to be cylindrical or else to have a box-shaped outer contour and has a clamping area on the inside for accommodating the connecting conductors to be clamped on. In the upper half of the clamping body 12, i.e., in the half facing the terminal opening 9, said clamping body 12 has an internal thread 23, into which a clamping screw 24, which has a corresponding external thread 25, can be screwed in the direction of the directional arrow 50 and from which it can be unscrewed.

The clamping screw 24 has an actuating end 26 having a slot 28 for the engagement of an actuating tool, for example a screwdriver, and a clamping end 30 opposite the actuating end 26, with which clamping end a connecting conductor (not illustrated here) can be fixedly clamped against a conductor bar 36 by means of pressure. The slot 28 can in this case have all possible known configurations or profiles for interacting with a large number of known actuating tools, for example a cross recess, a Pozidrive, a Torx profile, but a combination of various profiles can also be used.

In the embodiment shown here, the conductor bar 36 is mounted fixed to the housing in the interior of the clamping area. It divides the clamping area into a front clamping area 20 between the conductor bar 36 and the terminal opening 9, and a rear clamping area 21 between the conductor bar 36 and the limiting web 17, which delimits the clamping body 12 towards the fastening side 4. The clamping body 12 is guided such that it is longitudinally displaceable parallel to the narrow side wall in the terminal accommodating area. By the clamping screw being screwed in, first the clamping end of the clamping screw is pressed against the conductor inserted into the front clamping area and clamps it against the conductor bar. When the screwing-in movement of the clamping screw is continued, said clamping screw is supported to a certain extent on the conductor bar, and the clamping body is moved upwards in the direction towards the face side until finally the limiting web 17 presses the busbar inserted into the rear clamping area 21 against the conductor bar.

The conductor bar 36 runs into the device interior into an outgoing end 37, which forms a connecting conductor and at which further components and assemblies of the service switching device are connected, for example releases or contact points. At its free end, the conductor bar 36 is bent back in the form of a U, so that a bow-shaped segment 361 and a limb 362, which adjoins said bow-shaped segment and runs parallel to the conductor bar in the rear clamping area 21, are produced. If the connection lug of a busbar is now inserted into the rear clamping area 21, said connection lug is surrounded by the limb 362 and the limiting web 17 on both sides, and tightening of the clamping screw 24 ensures good mechanical and electrical contact.

The clamping screw 24 can have a pressure plate 32 at its clamping end 30.

If the clamping screw 30 is screwed onto the conductor bar 36, as is illustrated in FIG. 2, i.e., without connecting conductors inserted in the front clamping area 20, the shaft of the clamping screw 24 is accessible for undesired touching contact through the front housing opening 91. In order to eliminate this source of hazard, a terminal covering part 60 is plugged on in a peripheral groove 301 at the clamping end 30 of the clamping screw 24.

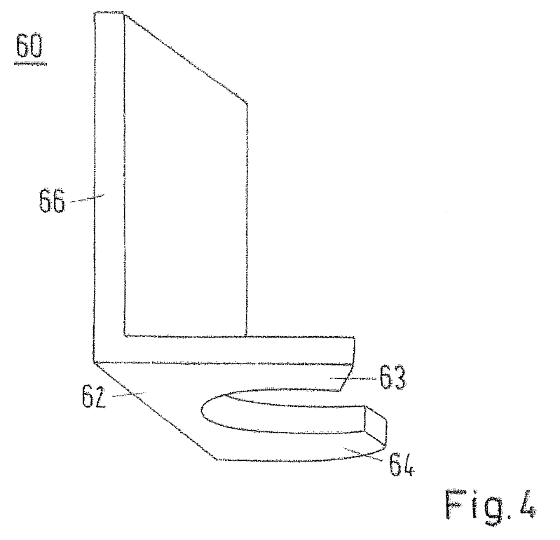

The exemplary terminal covering part 60 (see FIG. 4) has an approximately L shape and is in the form of a fork at a first limb, the short limb 62. The two sprung limb elements 63, 64 thus produced comprise an inner contour, which approximately corresponds to the outer contour of the peripheral groove 301 at the clamping end 30 of the clamping screw 24, so that the terminal covering part 60 can be joined on in a latching manner with the first limb 62 at the clamping end 30 of the clamping screw 24. The terminal covering part 60 is thereby in each case carried along in the movement direction 50 of the clamping screw 24 when it is screwed in and unscrewed.

A plate-shaped, second limb 66 runs approximately at right angles to the first limb 62 of the terminal covering part 60. The plate-shaped limb 66 covers that part of the front clamping area 20 which is above the clamping end 30 of the clamping screw 24 so as to protect it against touching contact from the side of the front housing opening 61.

In the terminal accommodating area, the connection terminal 10 with the terminal covering part 60 is fitted in such a way that the plate-shaped second limb 66 of the terminal covering part 60 is guided on the inside of the housing wall in the region of the front housing opening 91 parallel to the extent of the rear narrow side 6. As a result, damage to the terminal covering part owing to inappropriate handling of the service switching device is avoided.

The terminal covering part 60 includes (e.g., consists of) an insulating material, for example of plastic.

In the embodiments shown here, the clamping screw 24 is a headless screw bolt, also referred to as a setscrew. This can be screwed completely into the clamping body 12 without a head protruding on the outside. However of course a connection terminal could also be designed to have a head screw.

The peripheral groove 301 can be introduced in a very favorable manner, for example by means of being rotated, in the otherwise known manufacture of the clamping screws.

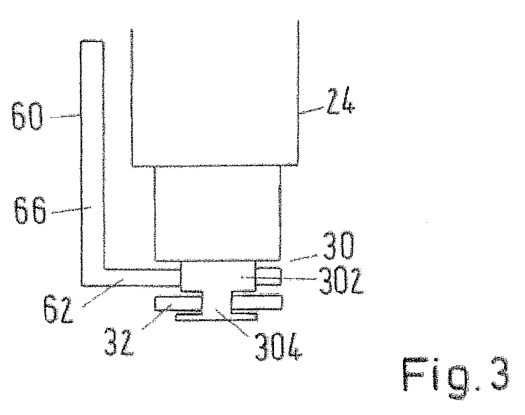

FIG. 3 shows an alternative configuration for a clamping screw 24 for use in a connection terminal 10 with a terminal covering part 60. In this case, a front shoulder 302 and a rear shoulder 304 are formed at the clamping end 30 of the clamping screw 24, the front shoulder having a smaller outer diameter than the screw shaft, and the rear shoulder 304 having a smaller outer diameter than the front shoulder 302.

The front shoulder 302 is used for clipping on the terminal covering part 60 with its first limb 62.

The rear shoulder 304 forms a type of pin and is used for riveting on the pressure plate. For this purpose, the pressure plate 32 is provided with an inner cutout, which is designed to guide it with this cutout via the pin 304. The free length of the pin 304 is in this case matched to the thickness of the pressure plate 32 in such a way that, once the pressure plate 32 has been positioned on the pin 304, said pin protrudes beyond the pressure plate 32 by a short section. This protruding section is used for subsequently riveting the pressure plate 32 by it being pressed flat.

The riveting of the pressure plate 32 can in this case be implemented in such a way that said pressure plate still remains capable of rotating on the pin 304. This makes it possible to achieve a situation in which the pressure plate is not rotated when the conductor is screwed fixedly on the conductor bar 36. This can have an advantage that there is no mechanical abrasion on the connecting conductor owing to a rotary movement in relation to the connecting conductor.

Overall, once the pressure plate 32 has been riveted on the pin 304, a type of groove results between the pressure plate 32 and the clamping end 30 of the clamping screw 24, which groove prevents the terminal covering part, which is clipped onto the front shoulder 302, from sliding downwards.

The modification of known clamping screws used for implementing this embodiment of a connection terminal, for example headless screw bolts, does not involve much in the way of complexity. The modified screw bolts can be produced from known screws simply by the two shoulders 302, 304 at the free screw end being turned on a lathe. Owing to the very high production numbers, there should also be no disadvantage in terms of costs in comparison with unmodified screw bolts.

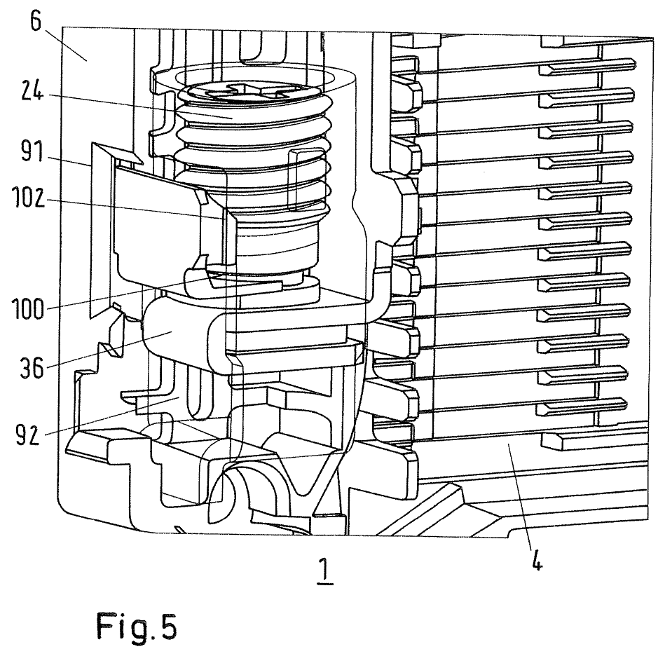

Consideration will now be given to FIG. 5. Here, the wall of the narrow side 6 has first guide means 100 in the form of an undercut, elongated groove on its longitudinal webs. On the longitudinal sides of the second upwardly pointing limb of the terminal covering part, said terminal covering part has second guide means 102 in the form of latching hooks or snap-action hooks. The terminal covering part in this embodiment can be clipped into the first housing opening 91 from the outside when the housing is closed, the first, fork-shaped limb of the terminal covering part entering the groove at the clamping end of the screw and snapping in there, and the latching hooks latching in the groove.

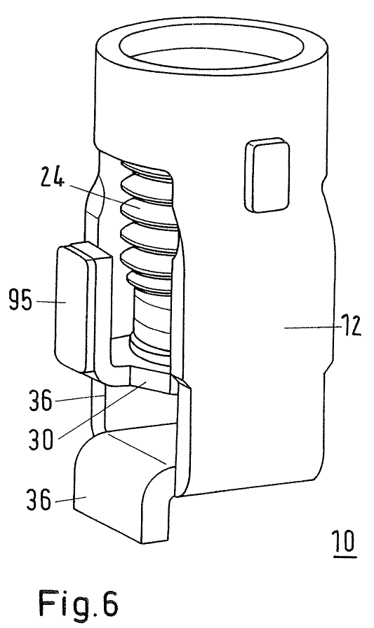

A further embodiment is shown in FIG. 6. There, the terminal covering part 60 is in the form of an angled sheet metal part. Its first limb has the aperture already mentioned above (hidden in the illustration in FIG. 6) and is riveted directly to the clamping screw at its clamping end in such a way that it can rotate. The angled sheet metal part is coated with an insulating material on the side with which touching contact can be made from the outside in the installed state, with the result that an insulating layer 95 is produced. This insulating layer may be, for example, a sprayed-on plastic layer. The terminal covering part can thereby be produced in a very stable and inexpensive manner.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

1 Service switching device
2 Front face side
3 Rear face side
4 Fastening side
5 Front narrow side
6 Rear narrow side
7 Broad side
8 Housing
9 Terminal opening
91 Front housing opening
92 Rear housing opening
10 Connection terminal
12 Clamping body
17 Limiting web
20 Front clamping area
21 Rear clamping area
23 Internal thread
24 Clamping screw
25 External thread
26 Actuating end of clamping screw
28 Actuating slot
30 Clamping end of clamping screw
301 Peripheral groove
302 Front shoulder
304 Rear shoulder
32 Pressure plate
36 Conductor bar
361 Bow-shaped segment
362 Limb of conductor bar
37 Outgoing end of conductor bar
50 Movement direction of clamping screw
60 Terminal covering part
62 First limb of terminal covering part
63,64 Sprung limb element
66 Plate-shaped second limb
91 First, front housing opening
92 Second, rear housing opening
95 Insulating layer
100 First guide means
102 Second guide means

We claim:

1. Service switching device comprising:
a housing having a face side, a fastening side and a narrow side lying therebetween;
a connection terminal, which is held in a terminal accommodating area of the housing which is located in a vicinity of the narrow side, having a clamping screw, which is accessible from the face side, having an actuating end and a clamping end opposite said actuating end;
a clamping body, in which a busbar and/or a connecting conductor can be pressed against a conductor bar by the clamping screw, the clamping body being accessible via a first housing opening in the wall of the narrow side; and
a terminal covering part which is coupled to the clamping end of the clamping screw to be carried along thereby in a movement direction of the clamping screw, which points in a direction of the face side, and which is dimensioned to completely cover the clamping area even when the clamping screw has been screwed onto a conductor bar.

2. Service switching device according to claim 1, comprising:
at least two clamping areas, which are accessible via a first and a second housing opening from a wall of the narrow side which is adjacent to the face side, which lie one behind the other in relation to the face side and which are separated from one another by a conductor bar inserted into the clamping body, for connecting a busbar and/or a connecting conductor; and
a first clamping area, which lies between the conductor bar and the face side, covered by the terminal covering part, which is coupled to the clamping end of the clamping screw to be carried along thereby in the movement direction of the clamping screw, which points in the direction of the face side and which is dimensioned to completely cover the first clamping area even when the clamping screw has been screwed onto the conductor bar.

3. Service switching device according to claim 1, wherein the terminal covering part has an L shape, having a first limb, whose end is in a form of a fork, and with which the terminal covering part can be latched onto a groove at the clamping end of the clamping screw to be carried along thereby in the movement direction of the clamping screw, and having a second limb dimensioned to completely cover the first clamping area even when the clamping screw has been screwed onto the conductor bar.

4. Service switching device according to claim 3, wherein the wall of the narrow side has, on longitudinal sides of the first housing opening, first guide means, which interact with second guide means, which are provided on longitudinal sides of the second limb, to guide the terminal covering part.

5. Service switching device according to claim 4, wherein the first guide means are elongated grooves, and the second guide means are snap-action hooks, so that the terminal covering part can be clipped onto the clamping screw and the first housing opening from the outside when the housing is closed.

6. Service switching device according to claim 1, wherein the terminal covering part has an L shape, having a first limb, which has an annular aperture, through which the clamping screw passes in a region of its clamping end.

7. Service switching device according to claim 6, wherein the first limb with the annular aperture is coupled to a groove at the clamping end of the clamping screw.

8. Service switching device according to claim 1, wherein the clamping screw is a headless screw bolt.

9. Service switching device according to claim 2, wherein the terminal covering part is guided at least partially in the first clamping area between the conductor bar and the inside of the narrow side wall.

10. Service switching device according to claim 9, wherein the terminal covering part has a second limb and is guided in the first clamping area between the clamping body and an inside of the narrow side wall.

11. Connection terminal for installation in the terminal accommodating area of a service switching device, comprising:
a housing;
a clamping screw, which has an actuating end and a clamping end opposite said actuating end;
a clamping body, in which at least one clamping area is formed, in which a busbar and/or a connecting conductor can be pressed against a conductor bar by the clamping screw; and
a terminal covering part, which is coupled to the clamping end of the clamping screw to be carried along thereby in a movement direction of the clamping screw, which points in a direction of the actuating end of the clamping screw, and which is dimensioned to completely cover the clamping area even when the clamping screw has been screwed onto a conductor bar.

12. Connection terminal according to claim 11, comprising:
a clamping body, in which two clamping areas, which lie one behind the other in relation to the movement direction of the clamping screw and are separated from one another by a conductor bar inserted into the clamping body, for connecting a busbar and/or a connecting conductor are formed; and
a first clamping area, which lies between the conductor bar and the clamping end of the clamping screw, covered by the terminal covering part, which is coupled to the clamping end of the clamping screw, to be carried along thereby in the movement direction of the clamping screw, which points in the direction of the actuating end of the clamping screw, and which is dimensioned to completely cover the first clamping area even when the clamping screw has been screwed onto the conductor bar.

13. Connection terminal according to claim 11, wherein the terminal covering part has an L shape, having a first limb, whose end is in a form of a fork, and with which the terminal covering part can be latched onto a groove at the clamping end of the clamping screw and can be carried along thereby in the movement direction of the clamping screw, and having a second limb pointing with its free end in the direction of the actuating end of the clamping screw.

14. Connection terminal according to claim 13, comprising:
guide means provided on the longitudinal sides of the second limb for guiding the terminal covering part in an opening of the housing of the service switching device.

15. Connection terminal according to claim 14, wherein the guide means are snap-action hooks, so that the terminal covering part can be clipped onto the clamping screw and the housing opening from the outside.

16. Connection terminal according to claim 11, wherein the terminal covering part has an L shape, having a first limb, which has an annular aperture, through which the clamping screw passes in a region of its clamping end.

17. Connection terminal according to claim 16, wherein the first limb with the annular aperture is coupled to a groove at the clamping end of the clamping screw.

18. Connection terminal according to claim 13, wherein the second limb of the terminal covering part is dimensioned to completely cover the first clamping area even when the clamping screw has been screwed onto the conductor bar.

19. Connection terminal according to claim 11, wherein the clamping screw is a headless screw bolt.

20. Connection terminal according to claim 11, wherein a groove at the clamping end is a peripheral groove.

21. Connection terminal according to claim 11, wherein the clamping screw has, at the clamping end, a coupling shoulder, with which the terminal covering part is coupled to the clamping end of the clamping screw.

22. Connection terminal according to claim 21, comprising:
a pressure plate, for pressing the connecting conductor or the busbar against the conductor bar, fitted to the coupling shoulder, and wherein the coupling shoulder together with the pressure plate act as a groove.

23. Connection terminal according to claim 22, wherein the pressure plate is mounted rotatably on the clamping end of the clamping screw.

24. Connection terminal according to claim 11, wherein the terminal covering part is formed from an insulating material.

25. Connection terminal according to claim 11, wherein the terminal covering part consists of metal, an outwardly pointing side which is accessible for touching contact being covered with an insulating material.
